(19) United States
(12) Patent Application Publication
(10) Pub. No.: US 2026/0366514 A1
(43) Pub. Date: Nov. 19, 2026

(54) VACUUM PUMP PASSIVE MAGNETIC BEARINGS

(71) Applicant: Edwards Limited, Burgess Hill, Sussex (GB)

(72) Inventor: Emiliano Lucchetta, Burgess Hill, Sussex (GB)

(21) Appl. No.: 19/490,703

(22) PCT Filed: May 14, 2024
(86) PCT No.: PCT/GB2024/051244

§ 371 Date: Dec. 5, 2025

(30) Foreign Application Priority Data
Jun. 8, 2023 (GB) 2308519.4

(51) Int. Cl. F04D 19/04; F16C 32/04

(52) U.S. Cl. CPC F04D 19/048; F04D 19/042; F16C 32/0425; F16C 2240/40; F16C 2360/45

(57) ABSTRACT

A passive magnetic bearing includes a rotor bearing half including one or more substantially annular rotor-side magnets and an opposing and substantially concentrically radially arranged stator bearing half including one or more substantially annular stator-side magnets; a radial gap extending between the rotor and stator bearing halves; wherein at least one rotor-side magnet has an axial extent which is from 3.5 times to 5.3 times the width of the radial gap, and a radial extent which is less than 1.2 times the axial extent of the respective magnet; and/or, wherein at least one stator-side magnet has an axial extent which is from 3.5 times to 5.3 times the width of the radial gap, and a radial extent which is less than 1.2 times the axial extent of the respective magnet.

### CROSS-REFERENCE TO RELATED APPLICATION

This application is a Section 371 National Stage Application of International Application No. PCT/GB2024/051244, filed May 14, 2024, and published as WO 2024/252119 A1 on Dec. 12, 2024, the contents of which is hereby incorporated by reference in its entirety and which claims priority of British Application No. 2308519.4, filed Jun. 8, 2023.

### FIELD

The present invention relates to passive magnetic bearings for vacuum pumps, vacuum pumps comprising the same, and to methods of manufacturing and designing the same.

### BACKGROUND

Generally, vacuum pumps use passive magnetic bearings to support the rotor, whose rotor elements (e.g. vanes) interact with a stator in order to convey a gaseous medium from an inlet to an outlet. In a turbomolecular vacuum pump, the stator typically includes a plurality of vanes configured to interact with a plurality of rotor vanes. A passive magnetic bearing is generally provided at least at a higher vacuum end of a turbomolecular vacuum pump.

A passive magnetic bearing typically comprises outer and inner bearing halves each including one or more magnets, generally in the form of passive magnet rings. Depending on the specific arrangement of the passive magnetic bearing, the outer bearing half may be the rotor bearing half or the stator bearing half, with the inner bearing half being the other of the rotor or stator bearing half. The bearing halves are placed in close proximity to one another, with an air gap located therebetween, and are generally configured to be in mutual repulsion, in use.

For passive magnetic bearings, the stiffness, of the passive magnetic bearing is of particular importance in order to provide secure positioning of the rotor with respect to the stator.

It is therefore generally desirable to determine an optimised design with respect to a required stiffness. For example, the design of a passive magnetic bearing can be optimised to provide the required stiffness for a minimum axial length, once the outer diameter of the bearing and the gap between inner and outer bearing halves is determined, and/or for the minimum permanent magnet material weight.

“Optimisation of repulsive passive magnetic bearings” (Moser, Sandtner, et al, IEEE Transactions on Magnetics, Vol. 42, No. 8, August 2006), herein referred to as “Moser”, sets out how particular aspect ratios can be used to determine an optimum magnet size for optimum stiffness. More specifically, the Moser paper plots optimum axial and radial extents of rotor and stator-side magnets as a function of bearing diameter, for a given radial air gap between the rotor and stator-side magnets as a function of the diameter.

Moser, which is an authority in the field, concludes that an optimal design can be found for a limited bearing volume and plots this data in order that designers of passive magnetic bearings can select suitable magnet size based on a particular construction space. Moser's design principle provides discrete design solutions for a set of a given number of magnet rings in a bearing, each solution representing the minimum length of a bearing for a given stiffness. This optimal design is based on the successive stacking permanent magnet layers for a given combination of air-gap and rotor diameter.

An example of such an implementation of this teaching is described in EP3135932B1, which describes a passive magnetic bearing for a vacuum pump, in particular a turbomolecular pump, wherein the axial height of an inner and/or outer magnet ring of the bearing is in a range between 3 and 5 times the radial air gap width, and the radial width of the inner and/or outer magnet ring is larger than or at most equal to 1.2 times, and smaller than or at most equal to 1.5 times the axial height of the respective ring.

However, the Applicant has identified a dichotomy between magnet stiffness and magnet number and size, which has not been addressed or adequately dealt with.

In theory, a supposed optimal radial stiffness could be achieved by producing a passive magnetic bearing having magnets which correspond to the aspect ratios taught in Moser and EP3135932B1. However, the prior art, and in particular Moser, necessitates a relatively greater number of bearing magnet layers, which must each be precisely fabricated, machined and assembled as a passive magnetic bearing half (either rotor or stator half).

Additionally, fabricating a passive magnetic bearing according to the prior art can result in an undesirable amount of magnet material waste by machining and/or a higher than optimal use of material in the permanent magnet rings.

Therefore, the theoretical ideal set out in the prior art does not assist the skilled person in providing a suitable real-world improved passive magnetic bearing, which takes not only the optimum radial stiffness into account, but also the more practical factors associated with fabrication and assembly.

Conversely, in practise, the aspect ratios of the magnets of known passive magnet bearings are typically much greater than the values advocated for by the aforementioned prior art, especially by Moser, leading to bearings with a much-reduced number of magnets but also a non-optimal stiffness and a significantly higher use of magnetic material.

While such practice has been used reasonably successfully, the pursuit of stiffer bearings and increased pumping performance, as well as the reduction of the magnetic material used, has brought about more complex technical requirements for passive magnetic bearings.

The present invention aims to solve these and other problems with the prior art.

The discussion above is merely provided for general background information and is not intended to be used as an aid in determining the scope of the claimed subject matter. The claimed subject matter is not limited to implementations that solve any or all disadvantages noted in the background.

### SUMMARY

Accordingly, in a first aspect, the present invention provides a passive magnetic bearing for a vacuum pump, in particular a turbomolecular vacuum pump passive magnetic bearing, the vacuum pump including a stator and a rotor configured to rotate relative to the stator about a rotational axis. The passive magnetic bearing comprises a rotor bearing half including one or more substantially annular rotor-side magnets and an opposing and substantially concentrically radially arranged stator bearing half including one or more substantially annular stator-side magnets. A radial gap extends between the rotor and stator bearing halves.

At least one, typically the or each, rotor-side magnet has an axial extent which is from around 3.5 times to around 5.3 times the width of the radial gap; and at least one, typically the or each, rotor-side magnet has a radial extent which is less than 1.2 times the axial extent of the respective magnet.

Additionally or alternatively, at least one, typically the or each, stator-side magnet has an axial extent which is from around 3.5 times to around 5.3 times the width of the radial gap; and at least one, typically the or each, stator-side magnet has a radial extent which is less than 1.2 times the axial extent of the respective magnet.

As used herein, the term “axial extent” refers to the width of a said annular magnet in a plane substantially parallel to the rotational axis of the vacuum pump rotor. The axial extent of a rotor- or stator-side magnet may be plotted as ‘h/g’, i.e. axial height as a function of the width of air gap between the rotor and stator.

As used herein, the term “radial extent” refers to the width of a said annular magnet in a plane substantially perpendicular to the rotational axis of the vacuum pump rotor. The radial extent refers to the width of the magnetic material of the annular magnet rather than a radius taken from a rotational axis of the bearing half. The radial extent of a rotor- or stator-side magnet may be plotted as ‘w/h’, i.e. radial width as a function of the axial height of the magnet.

Known prior art bearings comprise magnets which do not have these axial extent and radial extent ratios because the prior art teaches that an optimum magnet stiffness is not achieved by these ranges. More specifically, as set out in Moser, known magnets do not have an axial extent which is from around 3.5 times to around 5.3 times the width of the radial gap and a radial extent which is less than 1.2 times the axial extent of the respective magnet.

The known prior art teaches away from such a combined selection of axial and radial extents of the rotor-side and/or stator-side magnets. As described, it has been generally accepted in the prior art that if the axial extent of a rotor- or stator-side magnet is around or greater than around 3.5 times the width of the radial gap, the radial extent as a function of axial extent should be greater than 1.2 times in order to provide optimum stiffness.

In fact, in practise, known bearings have typically greater h/g aspect ratios, typically from 6 to 8 or above, with some cases just below 6 but above 5.3. In the past, emphasis has been placed on reducing the number of magnets for cost reasons as optimisation of the stiffness and reduction of the material used was not a priority.

By contrast, the applicant has surprisingly found that an intermediate axial extent as a function of radial gap width, in combination with a smaller radial extent, provides short magnetic bearing halves including fewer magnets than is taught in the prior art, while maintaining optimum or near optimum stiffness and using comparable or less magnetic material. Both attributes are very important in the pursuit of increased performance and sustainability. This is also advantageous because providing optimal stiffness with fewer magnets than previously taught reduces the machining requirement for the passive magnetic bearing, and thus cost compared to the prior art.

By identifying and addressing the dichotomy of optimum magnet stiffness and magnet number and size the applicant now provides, in the present invention, passive magnetic bearings for vacuum pumps which have suitable stiffness while requiring less material than the prior art, and with minimised material waste and machining effort and cost. In particular, providing a smaller radial extent, in combination with the greater axial extent in this range, provides a passive magnetic bearing requiring less material. This, in turn, reduces the weight of the passive magnetic bearing, as well as material and machining cost.

This specific combined selection of radial and axial extent of the rotor- and/or stator-side magnets of the rotor and/or stator bearing halves of the passive magnetic bearing, provides the unexpected technical advantage of providing improved stiffness density for a given size of passive magnetic bearings having fewer magnet layers.

In embodiments, the at least one rotor-side magnet and/or the at least one stator-side magnet may have a radial extent which is substantially equal to or greater than around 0.8 times the axial extent of the respective magnet.

In embodiments, the at least one rotor-side magnet and/or the at least one stator-side magnet may have a radial extent which is substantially equal to or less than around 1.195 times the axial extent of the respective magnet; optionally substantially equal to or less than around 1.19 times the axial extent of the respective magnet. In embodiments, the at least one rotor-side magnet and/or the at least one stator-side magnet may have a radial extent which is substantially equal to or less than around 1.18 times the axial extent of the respective magnet.

In embodiments, the at least one rotor-side magnet and/or the at least one stator-side magnet may have a radial extent which is from around 0.8 times to around 1.18 times the axial extent of the respective magnet.

In embodiments, the at least one rotor-side magnet and/or the at least one stator-side magnet may have an axial extent which is from around 3.5 times to around 5 times the width of the radial gap.

In embodiments, the at least one rotor-side magnet and/or the at least one stator-side magnet may have an axial extent which is from around 5 times to around 5.3 times the width of the radial gap.

Generally, the passive magnetic bearing may include rotor and stator bearing halves which have substantially the same axial extent and which comprise substantially the same, typically substantially exactly the same, number of magnet layers formed as annular magnet rings. Typically, each of the inner bearing half and outer bearing half comprise a plurality of magnet layers.

Thus, in embodiments, the inner bearing half and the outer bearing half may each comprise a corresponding plurality of axially adjacent magnet layers. Although, in embodiments, the inner bearing half and outer bearing half may have a dissimilar number of magnet layers.

In embodiments, the or each rotor-side magnet and the or each magnetically corresponding stator-side magnet may have a substantially common radial extent. In other words, corresponding rotor- and stator-side magnets may have substantially the same radial width.

In embodiments, the or each rotor-side magnet and the or each magnetically corresponding stator-side magnet may have a substantially common axial extent. In other words, corresponding rotor- and stator-side magnets may have substantially the same axial height.

In embodiments, each magnet layer of each bearing half may be in the form of a permanent magnet ring.

In embodiments, each permanent magnet ring of the bearing halves may have a substantially common axial extent and radial extent.

In embodiments, the or each rotor-side magnet and the or each stator-side magnet may comprise a neodymium magnet or neodymium magnet alloy. In embodiments, the or each rotor-side magnet and the or each stator-side magnet may comprise a samarium cobalt magnet, a neodymium iron boron magnet alloy, or any other magnet alloy.

In embodiments, the or each rotor-side magnet and/or the or each stator-side magnet may be axially magnetised, or radially magnetised. In embodiments, the rotor bearing half and/or stator bearing half may comprise a combination of axially and radially magnetised magnets, for example to form a Halbach array.

In a further aspect, the present invention provides a vacuum pump comprising a passive magnetic bearing according to any preceding aspect. In embodiments, the vacuum pump may comprise a plurality of said passive magnetic bearings. For example, the vacuum pump may comprise a first said passive magnetic bearing at a higher vacuum end of the vacuum pump and a second said passive magnetic bearing at a lower vacuum end of the vacuum pump.

In embodiments, the vacuum pump may be a turbomolecular vacuum pump.

In embodiments, the or each rotor-side magnet and the or each stator-side magnet may comprise a neodymium magnet or neodymium magnet alloy. In embodiments, the or each rotor-side magnet and the or each stator-side magnet may comprise a samarium cobalt magnet, a neodymium iron boron magnet alloy, or any other alloy.

In embodiments, the or each rotor-side magnet and/or the or each stator-side magnet may be axially or radially magnetised.

In a further aspect, the present invention provides a method of designing a passive magnetic bearing for a vacuum pump, in particular a turbomolecular vacuum pump, the method comprising the steps of:
a) providing a rotor bearing half including one or more substantially annular rotor-side magnets and an opposing and substantially concentrically radially arranged stator bearing half including one or more annular stator-side magnets, the rotor bearing half and stator bearing half together forming a passive magnetic bearing having an outer diameter;
b) determining the width of a radial gap extending between the rotor bearing half and stator bearing half based on the outer diameter of the passive magnetic bearing;
c) configuring at least one, typically each, rotor-side magnet and/or at least one, typically each, stator-side magnet to have an axial extent which is from around 3.5 times to around 5.3 times the radial gap width; and
d) configuring at least one, typically each, rotor-side magnet and/or at least one, typically each, stator-side magnet to have a radial extent which is less than 1.2 times the axial extent of the respective magnet.

In embodiments, step d) may include configuring the at least one rotor-side magnet and/or the at least one stator-side magnet to have a radial extent which is substantially equal to or greater than around 0.8 times the axial extent of the respective magnet.

In embodiments, step d) may include configuring the at least one rotor-side magnet and/or the at least one stator-side magnet to have a radial extent which is substantially equal to or less than around 1.195 times the axial extent of the respective magnet; optionally substantially equal to or less than around 1.19 times the axial extent of the respective magnet. In embodiments, step d) may include configuring the at least one rotor-side magnet and/or the at least one stator-side magnet to have a radial extent which is substantially equal to or less than around 1.18 times the axial extent of the respective magnet.

In embodiments, step d) may include configuring the at least one rotor-side magnet and/or the at least one stator-side magnet to have a radial extent which is from around 0.8 times to around 1.18 times the axial extent of the respective magnet. In embodiments, step d) may include configuring the at least one rotor-side magnet and/or the at least one stator-side magnet to have a radial extent which is greater than 0.95 times the axial extent of the respective magnet.

In embodiments, step c) may include configuring the at least one rotor-side magnet and/or the at least one stator-side magnet to have an axial extent which is from around 3.5 times to around 5 times the width of the radial gap.

In embodiments, step c) may include configuring the at least one rotor-side magnet and/or the at least one stator-side magnet to have an axial extent which is from around 5 times to around 5.3 times the width of the radial gap.

In embodiments, the method may comprise the step of configuring the or each rotor-side magnet and the or each magnetically corresponding stator-side magnet such that they have a substantially common radial extent.

In embodiments, the method may comprise the further step of configuring the or each rotor-side magnet and the or each magnetically corresponding stator-side magnet such that they have a substantially common axial extent.

In embodiments, step a) may include providing each of the rotor bearing half and stator bearing half with a corresponding plurality of axially adjacent magnet layers.

In embodiments, each magnet layer may be in the form of a permanent magnet ring.

In embodiments, the method may further comprise the step of configuring each permanent magnet ring of each bearing half to have a substantially common axial extent and radial extent.

In embodiments, the method may include the step of axially or radially magnetising the or each rotor-side magnet and/or the or each stator-side magnet.

In a further aspect, the present invention provides a method of manufacturing a vacuum pump passive magnetic bearing, the method comprising the step of fabricating a passive magnetic bearing according to the design of any preceding aspect.

In embodiments, the method of manufacturing may comprise one or more additive manufacturing processes.

In a further aspect, the present invention provides a computer readable medium storing data which defines both a digital representation of the vacuum pump passive magnetic bearing or the vacuum pump of any suitable preceding aspect, and operating instructions adapted to control a manufacturing device to fabricate the passive magnetic bearing or vacuum pump using the digital representation of the passive magnetic bearing or vacuum pump when said data is relayed to the manufacturing device.

In embodiments, the manufacturing device may be an additive manufacturing device, or may comprise additive manufacturing modes or modules.

In a further aspect, the present invention provides rotor or stator bearing half of a vacuum pump passive magnetic bearing, comprising one or more substantially annular magnets configured to operably magnetically engage the magnets of an opposing rotor or stator bearing half of the passive magnetic bearing; wherein each magnet of the rotor or stator bearing half has an axial extent which is from around 3.5 times to around 5.3 times the width of a radial gap formed between the rotor or stator bearing half and the opposing rotor or stator bearing half when the bearing halves are operably magnetically engaged; and wherein each magnet of the rotor or stator bearing half has a radial extent which is less than 1.2 times the axial extent of the respective magnet.

In a further aspect, the present invention provides a compressor passive magnetic bearing comprising a rotor bearing half including one or more substantially annular rotor-side magnets and an opposing and substantially concentrically radially arranged stator bearing half including one or more substantially annular stator-side magnets. A radial gap extends between the rotor and stator bearing halves.

At least one, typically the or each, rotor-side magnet has an axial extent which is from around 3.5 times to around 5.3 times the width of the radial gap; and at least one, typically the or each, rotor-side magnet has a radial extent which is less than 1.2 times the axial extent of the respective magnet.

Additionally or alternatively, at least one, typically the or each, stator-side magnet has an axial extent which is from around 3.5 times to around 5.3 times the width of the radial gap; and at least one, typically the or each, stator-side magnet has a radial extent which is less than 1.2 times the axial extent of the respective magnet.

For the avoidance of doubt, features of aspects and embodiments described herein may be combined, and still fall within the scope of the present invention.

The summary is provided to introduce a selection of concepts in a simplified form that are further described in the detailed description. This summary is not intended to identify key features or essential features of the claimed subject matter, nor is it intended to be used as an aid in determining the scope of the claimed subject matter.

### BRIEF DESCRIPTION OF THE DRAWINGS

Preferred features of the present invention will now be described, by way of example, with reference to the accompanying drawings, in which:

FIG. 1 illustrates a cross sectional view of a passive magnetic bearing for a vacuum pump.

FIG. 2 illustrates rotor- and stator-side bearing halves each incorporating a plurality of magnet rings.

FIG. 3 illustrates a graph in which stiffness k of passive magnetic bearing magnets for different ratios of axial extent and radial gap.

FIG. 4 illustrates a graph in which stiffness and mass of passive magnetic bearing magnets for different ratios of axial and radial extents.

### DETAILED DESCRIPTION

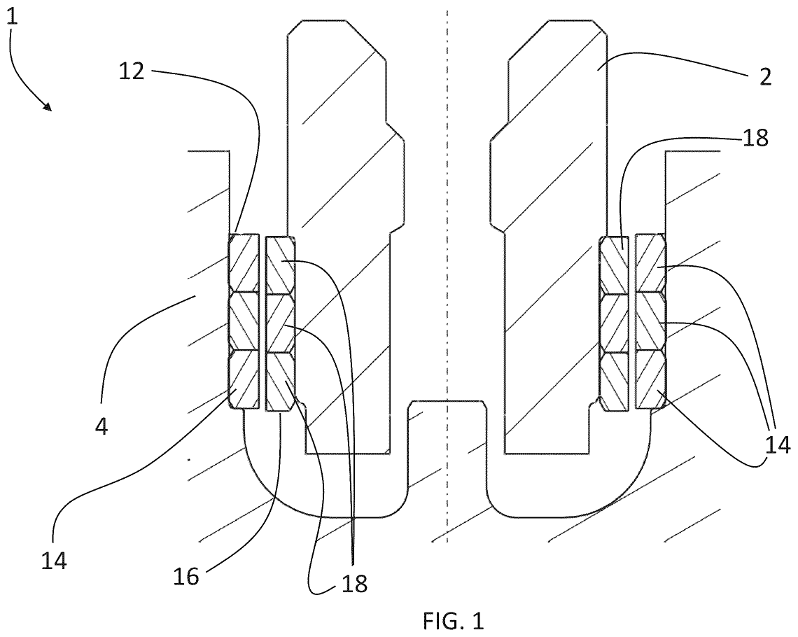

The present invention provides a passive magnetic bearing for a vacuum pump, in particular a turbomolecular vacuum pump passive magnetic bearing. As shown in FIG. 1, the vacuum pump 1 includes a stator 2 and a rotor 4 configured to rotate relative to the stator about a rotational axis (‘A’), in use.

The passive magnetic bearing comprises a rotor bearing half 12 and a stator bearing half 16. Typically, and in the vacuum pump of FIG. 1, the stator bearing half is an inner bearing half and the rotor bearing half is an outer bearing half, but it is envisaged that the stator bearing half may be an outer bearing half and the rotor bearing half may be an inner bearing half.

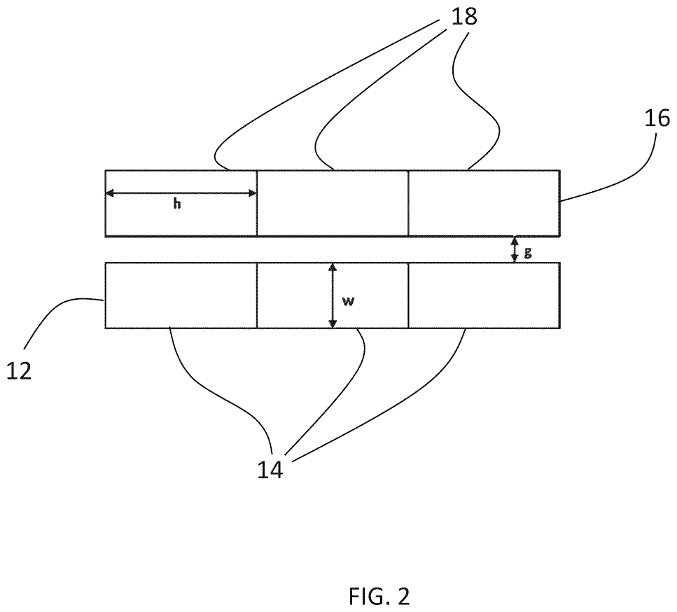

In FIGS. 1 and 2, the rotor bearing half 12 includes a plurality of substantially annular rotor-side magnets 14 and the opposing and substantially concentrically radially arranged stator 16 bearing half includes a corresponding plurality of substantially annular stator-side magnets 18.

Referring to FIG. 2, a radial gap, g, extends between the rotor and stator bearing halves 12, 16.

At least one, typically the or each, rotor-side magnet 14 has an axial extent, h, which is from around 3.5 times to around 5.3 times the width of the radial gap, g; and at least one, typically the or each, rotor-side magnet 14 has a radial extent, w, which is less than 1.2 times the axial extent of the respective magnet.

Additionally or alternatively, at least one, typically the or each, stator-side magnet 18 has an axial extent which is from around 3.5 times to around 5.3 times the width of the radial gap; and at least one, typically the or each, stator-side magnet 18 has a radial extent which is less than 1.2 times the axial extent of the respective magnet. The measured dimensions and aspect ratios of the rotor- and stator-side magnets in FIGS. 1 and 2 may not necessarily be exact, depending on their reproduction etc.; they are provided for illustrative purposes.

By way of example, the design of a passive magnetic bearing according to the present invention is now described.

Assuming that the outer diameter of the outer bearing half (be it rotor or stator half) of a passive magnetic bearing or the inner diameter of the rotor cavity housing is approximately 28 mm and the radial gap between the inner and outer bearing halves is approximately 0.6 mm, the

$$\frac{g}{D}$$

ratio would be around 0.025, where g is the width of the air gap between rotor and stator halves and D is the diameter of the bearing.

According to the teaching of the known prior art, including ‘Moser’, with the above parameters the optimum design of the passive magnetic bearing would yield the following aspect ratios:

$$\frac{{h}_{opt}}{D} = 0.065 ;$$

$$\frac{{d}_{opt}}{D} = 0.83 ; and$$

$$\frac{{a}_{opt}}{D} = 0.661 ,$$

where hₒₚₜ is the optimum height of one permanent magnet layer, dₒₚₜ is the optimum diameter defining the location of the air gap between rotor and stator, aₒₚₜ is the optimum diameter of the main rotor axis, and D is the diameter of the bearing.

The above aspect ratios can be developed to provide the following aspect ratios:

$$\frac{{h}_{opt}}{g} = 3.02$$

$$\frac{{w}_{o , opt}}{g} = 1.15$$

$$\frac{{w}_{i , opt}}{g} = 1.15 ,$$

where w_{o,opt} is the optimum radial extent of the magnet of an outer bearing half (be it stator- or rotor-side), w_{i,opt} is the optimum radial extent of the magnet of an inner bearing half, and g is the width of the air gap between outer and inner bearing halves.

Therefore, hₒₚₜ equals 1.81, wₒ equals 2.08 mm, and wᵢ equals 2.03 mm.

The bearing stiffness for a resulting passive magnetic bearing design, formed by an increasing number of magnet layers, can be calculated using finite element analysis (FEA), for example. Once the required stiffness is known, the number, N, of layers required can be determined.

Table 1 below shows the calculated axial stiffness magnitude for a bearing formed with different numbers of layers, where the magnet material used is, for example, neodymium.

TABLE 1

| N initial | K Opt_N [N/mm] |
|---|---|
| 3 | 115 |
| 4 | 158 |
| 5 | 200 |
| 6 | 242 |
| 7 | 285 |
| 8 | 326 |

The magnitude of the radial stiffness of the bearing can be calculated by dividing the values in Table 1 by two.

The above rings have optimal dimensions, including height and thus maximum stiffness for unit height. However, the resulting bearing is typically formed by a relatively large number of rings. Assembly is therefore more difficult and expensive, in particular because machining of the rings to required tolerances is more burdensome and costly. Additionally, the resulting rings are thin and not robust, and can be difficult to manufacture and handle. Using fewer and higher magnets as set out by the present invention is advantageous.

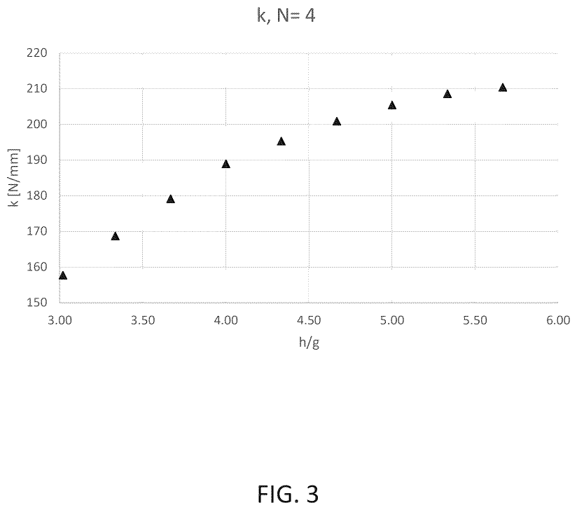

FIG. 3 plots the stiffness for magnets versus

$$\frac{h}{g}$$

when the magnets height is increased while keeping the same outer diameter, D, air gap, g, and

$$\frac{w}{h}$$

ratio. The plot shows that the stiffness substantially stops increasing for higher

$$\frac{h}{g}$$

values.

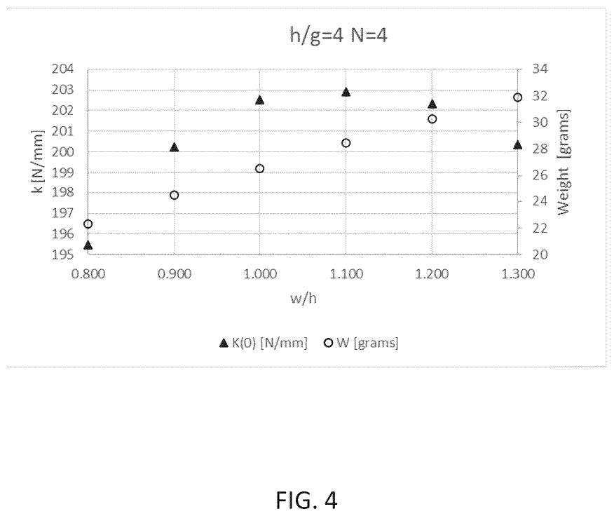

Additionally, FIG. 4 shows the impact of the aspect ratio,

$$\frac{w}{h} ,$$

on the stiffness and weight of a magnet ring stack.

The plot of FIG. 4 shows that a local stiffness maximum is obtained for a

$$\frac{w}{h}$$

ratio of less than 1.2, with the stiffness decreasing above a

$$\frac{w}{h}$$

ratio of more than 1.2. The weight of the ring increases monotonically with

$$\frac{w}{h} .$$

Table 2 below shows the possible combinations of stacks with one less magnet layer, having the same stiffness as described in the prior art, including ‘Moser’, and producing a minimised increase of stack height and bearing weight. In Table 2, two sets of results are provided:

$$\frac{w}{h}$$

of <1.2, and

$$\frac{w}{h}$$

of ≥1.2.

TABLE 2

| | | | | | | weight |
|---|---|---|---|---|---|---|
| N initial | N reduced | h reduced | h/g | w/h | h ratio | ratio |
| 4 | 3 | 3 | 5.00 | 1.1 | 1.24 | 1.77 |
| 4 | 3 | 3.2 | 5.33 | 1.3 | 1.33 | 2.18 |
| 5 | 4 | 2.6 | 4.33 | 0.9 | 1.15 | 1.27 |
| 5 | 4 | 2.6 | 4.33 | 1.3 | 1.15 | 1.66 |
| 6 | 5 | 2.4 | 4.00 | 0.9 | 1.10 | 1.14 |
| 6 | 5 | 2.4 | 4.00 | 1.3 | 1.10 | 1.51 |
| 7 | 6 | 2.2 | 3.67 | 1.1 | 1.04 | 1.18 |
| 7 | 6 | 2.2 | 3.67 | 1.3 | 1.04 | 1.34 |
| 8 | 7 | 2.2 | 3.67 | 0.9 | 1.06 | 1.02 |

As demonstrated by Table 2, improved results are achieved when the

$$\frac{h}{g}$$

ratios of higher magnets are smaller, as can be expected from FIG. 3. Moreover, when

$$\frac{w}{h}$$

is below 1.2, the ratio between the weight of a magnet stack with a reduced number of higher magnets and the weight of a prior art design is considerably lower than when

$$\frac{w}{h}$$

is above 1.2.

Therefore, the use of magnets with

$$\frac{h}{g}$$

of less than 5.3 times and

$$\frac{w}{h}$$

of less than 1.2 times minimises the impact on the magnet stack height and weight compared to the prior art, while keeping substantially the same stiffness. When fewer magnets are used, not only is machining cost reduced and ease of assembly increased, but less material is typically discarded during a machining operation. This helps to offset any increase in material usage that may result while maintaining the same, maximum stiffness value.

The same method can be used to minimise the decrease of stiffness when fewer, higher magnets are to be used without increasing the bearing height and weight. Table 3 below shows the calculations with

$$\frac{w}{h}$$

of less than 1.2 and with

$$\frac{w}{h}$$

of greater than 1.2. A

$$\frac{w}{h}$$

of 1.3 is used for illustration. When the bearing weight is not increased and is kept substantially the same, the bearing height is kept the same or is lower, and fewer axially taller magnets are used.

TABLE 3

| | | | | | weight | |
|---|---|---|---|---|---|---|
| N initial | N reduced | h reduced | h/g | w/h | ratio | k ratio |
| 4 | 3 | 2.4 | 4.00 | 0.8 | 0.93 | 0.85 |
| 4 | 3 | 2 | 3.33 | 1.3 | 0.99 | 0.78 |
| 5 | 4 | 2.3 | 3.83 | 0.9 | 1.01 | 0.92 |
| 5 | 4 | 2 | 3.33 | 1.3 | 1.06 | 0.85 |
| 6 | 5 | 2.2 | 3.67 | 0.9 | 0.97 | 0.94 |
| 6 | 4 | 2.2 | 3.67 | 1.3 | 1.04 | 0.75 |

Table 3 shows that the stiffness ratio with the same bearing weight is higher when

$$\frac{w}{h}$$

is less than 1.2 than when

$$\frac{w}{h}$$

is greater than 1.2. This is because, for the same right height, the radial width is greater. Therefore, the ring weight increases without a corresponding increase in stiffness. A shorter ring must be chosen, and this results in a lower stiffness. Therefore, a

$$\frac{w}{h}$$

of less than 1.2, produces the maximum stiffness/weight ratio when fewer, higher rings than what is generally accepted in the prior art are used, to produce a more cost-effective, more robust and easier to assemble bearing.

In practice, it may be that the desired stiffness falls in between the optimum stiffnesses determined by the prior art principles for two different number of layers, N and +1, where the stiffness with N layers is insufficient and the stiffness of N+1 is excessive. Excessive stiffness may result in higher than desired vibrations or excessive preload being applied to the roller bearing, where present. The present invention can thus be used to produce a bearing of required stiffness where N layers are provided and using the minimum amount of permanent magnet material. In most cases, an increase of the rings axial height and decrease in number of rings is desired and the present invention can be used to achieve this while minimising the impact on magnetic material used.

It will be appreciated that various modifications may be made to the embodiments shown without departing from the spirit and scope of the invention as defined by the accompanying claims as interpreted under patent law.

Although elements have been shown or described as separate embodiments above, portions of each embodiment may be combined with all or part of other embodiments described above.

Although the subject matter has been described in language specific to structural features and/or methodological acts, it is to be understood that the subject matter defined in the appended claims is not necessarily limited to the specific features or acts described above. Rather, the specific features and acts described above are described as example forms of implementing the claims.

1. A vacuum pump passive magnetic bearing, the vacuum pump including a stator and a rotor configured to rotate about a rotational axis relative to the stator; the passive magnetic bearing comprising:
a rotor bearing half and a stator bearing half;
a radial gap extending between the rotor and stator bearing halves;
wherein at least one of the rotor bearing half and the stator bearing half comprises a substantially annular magnet that has an axial extent which is from around 3.5 times to around 5.3 times the width of the radial gap, and a radial extent which is less than 1.2 times the axial extent of the magnet.

2. The vacuum pump passive magnetic bearing of claim 1, wherein the magnet has a radial extent which is substantially equal to or greater than about 0.8 times the axial extent of the magnet.

3. The vacuum pump passive magnetic bearing of claim 1, wherein the magnet has an axial extent which is from around 3.5 to around 5 times the width of the radial gap.

4. The vacuum pump passive magnetic bearing of claim 1, wherein the magnet has an axial extent which is from around 5 to around 5.3 times the width of the radial gap.

5. The vacuum pump passive magnetic bearing of claim 1, wherein the annular magnet of the rotor bearing half and the annular magnet of the stator bearing half have a substantially common radial extent; and/or wherein the annular magnet of the rotor bearing half and the annular magnet of the stator bearing half have a substantially common axial extent.

6. A vacuum pump, in particular a turbomolecular vacuum pump, comprising a vacuum pump passive magnetic bearing according to claim 1.

7. The vacuum pump passive magnetic bearing of claim 1, wherein the magnet is axially or radially magnetised.

8. A method of designing a vacuum pump passive magnetic bearing, the method comprising the steps of:
a) providing a rotor bearing half and an opposing and substantially concentrically radially arranged stator bearing half, the rotor bearing half and stator bearing half together forming a passive magnetic bearing having an outer diameter;
b) determining the width of a radial gap extending between the rotor bearing half and stator bearing half based on the outer diameter of the passive magnetic bearing;
c) configuring a magnet in at least one of the rotor bearing half and the stator bearing half to have an axial extent which is from around 3.5 times to around 5.3 times the radial gap width;
d) configuring the magnet to have a radial extent which is less than 1.2 times the axial extent of the respective magnet.

9. The method of claim 8, wherein step d) includes configuring the magnet to have a radial extent which is substantially equal to or greater than about 0.8 times the axial extent of the respective magnet.

10. The method of claim 8, wherein step c) includes configuring the magnet to have an axial extent which is from around 3.5 times to around 5 times the width of the radial gap.

11. The method of claim 8, wherein step c) includes configuring the magnet to have an axial extent which is from around 5 times to around 5.3 times the width of the radial gap.

12. The method of claim 8, further comprising configuring the magnet of the rotor and the magnet of the stator such that the magnet of the rotor and the magnet of the stator have a substantially common radial extent; and/or further comprising configuring the magnet of the rotor and the magnet of the stator such that the magnet of the rotor and the magnet of the stator have a substantially common axial extent.

13. A method of manufacturing a vacuum pump passive magnetic bearing, the method comprising the step of fabricating a vacuum pump passive magnetic bearing according to the design of claim 8.

14. A computer readable medium storing data which defines both a digital representation of the vacuum pump passive magnetic bearing of claim 1, and operating instructions adapted to control a manufacturing device to fabricate the passive magnetic bearing or vacuum pump using the digital representation of the vacuum pump passive magnetic bearing.

15. A rotor or stator bearing half of a vacuum pump passive magnetic bearing, comprising one or more substantially annular magnets configured to operably magnetically engage the magnets of an opposing rotor or stator bearing half of the passive magnetic bearing;
wherein each magnet of the rotor or stator bearing half has an axial extent which is from around 3.5 times to around 5.3 times the width of a radial gap formed between the rotor or stator bearing half and the opposing rotor or stator bearing half when the bearing halves are operably magnetically engaged; and
wherein each magnet of the rotor or stator bearing half has a radial extent which is less than 1.2 times the axial extent of the respective magnet.
